(19) United States
(12) Patent Application Publication
(10) Pub. No.: US 2003/0101524 A1
(43) Pub. Date: Jun. 5, 2003

(54) Produce handling material

(76) Inventor: William H. Tew III, Fairport, NY (US)

Correspondence Address: GREENWALD & BASCH, LLP, 349 WEST COMMERCIAL STREET, SUITE 2490, EAST ROCHESTER, NY, 14445, US

(21) Appl. No.: 09/996,707

(22) Filed: Nov. 30, 2001

(51) Int. Cl. A23N 12/00

(52) U.S. Cl. 15/3.11; 15/3.14; 15/3.16

(57) ABSTRACT

The present invention is a method and apparatus for food handling, comprising a member for the support of a food item; and a covering for the member, wherein said covering is formed with an anti-microbial agent to retard the growth of microbes. In a particular embodiment, the covering comprises a foam padding.

This invention relates generally to an improved produce handling material, and more particularly to the use of anti-microbial additives in the production of padding and other materials for produce handling equipment.

### BACKGROUND AND SUMMARY OF THE INVENTION

The present invention is directed to the application of antimicrobial agents to materials that are employed in the food processing and packing industry, particularly including the processing, handling, packing and storing of produce (e.g., fruits and vegetables) that must be sorted and washed before being processed or sold to the consumer. In such applications, the equipment employed is specifically designed to handle produce in a manner that will not reduce the value of the produce through rough handling that may cause damage or bruising of the produce. For example, various sorters, conveyors, washers and sorting tables of this type have been sold by TEW Manufacturing Corp. since the 1950s.

However, in many applications, the produce that is handled is washed. The liquid generated by or associated with washing allows any microbes associated with the produce to easily penetrate into seams, cracks, or other surfaces susceptible to the absorption or collection of liquids. While such equipment may be cleaned using well-known techniques, certain aspects of the equipment may nonetheless be difficult to clean in a manner suitable to remove all microbes. In particular, padding or water-absorbing elements of produce and food-handling equipment may be particularly difficult to clean. For example, if a closed or open-cell foam padding is cut or scraped in use, the cells or openings that are exposed provide dark/damp surfaces that are prone to the growth of bacteria and fungi. Accordingly, the present invention is directed toward improved materials that may be employed in produce and other food-handling equipment to reduce or eliminate the likelihood of the materials providing a location for the growth of microbes.

Heretofore, a number of patents and publications have disclosed antibacterial and antifungal materials and applications for such materials, and the following are hereby incorporated by reference. The relevant portions of the patents and publications and may be briefly summarized as follows:

U.S. Pat. No. 5,586,643 and U.S. Pat. No. 5,906,269 to Zabron et al., disclose the manufacture and use of an antibacterial agent in conveyor belting (modular and continuous). Moreover, such belting is described as that which may be applicable for use in the handling of produce.

U.S. Pat. No. 5,238,749 to Cueman et al., issued Aug. 24, 1993, teaches a process for coating substrates with a substance that not only provides chemical and corrosion resistance, but also inhibits the passage and proliferation of germs.

U.S. Pat. No. 6,309,741 B1 to Doyle, issued Oct. 30, 2001, is directed to a shopping cart shelf and seat padding that employs a closed-cell, FDA-approved foam (NOBRUZE PROTECTIVE PADDING™) to reduce damage to fruits, vegetables, baked goods and other delicate and sensitive items.

U.S. Pat. No. 4,937,273 to Okuyama et al., issued Jun. 26, 1990, teaches a process for producing a flexible polyurethane foam having antibacterial properties. In particular, the patent teaches the use of an inorganic antibacterial agent such as silver ions, copper ions and zinc ions, supported on zeolite.

WO 00/64259 by Healthshield Technologies, LLC (Freedman et al.), published Nov. 2, 2000, is directed to the formation of an ice chest or cooler using rigid foam that includes an inorganic antimicrobial agent (e.g., silver cations with zeolite).

In accordance with the present invention, there is provided a produce handling machine, comprising: a produce receiver having a generally horizontal receiving surface and at least two opposing sides adjacent thereto to retain produce on the receiving surface; a produce washer, adjacent the produce receiver, for washing the produce as it is transported therethrough; a water absorber, adjacent said produce washer, for movably supporting the produce and to remove excess water from the produce as it exits the washer; and a foam padding covering at least one produce-contacting surface of the machine, wherein said foam padding is intended to reduce bruising of the produce and where said foam padding is formed with an anti-microbial agent to retard the growth of microbes within the padding.

In accordance with another aspect of the present invention, there is provided a produce handling machine, comprising: at least one produce-contacting surface; and a foam padding covering at least a portion of said produce-contacting surface of the machine, wherein said foam padding is intended to reduce bruising of the produce contacting the surface and where said foam padding is formed with an anti-microbial agent to retard the growth of microbes on the padding.

In accordance with yet another aspect of the present invention, there is provided a food handling apparatus, comprising: a stationary member for the support of a food item; and a covering for at least one food-contacting surface of the member, wherein said covering is formed with an anti-microbial agent to retard the growth of microbes.

One aspect of the invention deals with a basic problem in the handling of food during processing, particularly produce, that of preventing damage and contamination of the food. This aspect is further based on the discovery of a technique that alleviates this problem. The technique uses an antimicrobial agent in the production of foam padding and other materials of the food-processing and packing process to reduce the likelihood of growing and spreading microbes. One aspect of the invention is based on the observation of problems with conventional produce handling and packing equipment—that there is no easy way, short of replacing padding, to prevent or restrict the growth and spread of microbes on or in such padding over time. This aspect is based on the discovery of a material that alleviates these problems by combining the padding characteristics along with suitable antimicrobial characteristics through additives or agents employed in the manufacture of the padding or other materials.

Another aspect of the invention is directed to the use of anti-microbial agents or additives for use with other components of food processing, storage and packaging techniques. For example, washing equipment may employ scrubbing materials and brushes that are manufactured with anti-microbial agents so as to prevent or retard the growth of bacteria and fungus therein.

The techniques described herein are advantageous because they are simple to implement and make it unnecessary to replace padding. In addition, it can be used in other areas of food processing and marketing. The techniques of the invention are advantageous because they provide a range of alternatives, each of which is useful in appropriate situations. As a result of the invention, produce processing will become more cost-efficient as processors and packers will not need to replace padding and other materials as frequently.

### BRIEF DESCRIPTION OF THE DRAWINGS

FIGS. 1 and 2 are exemplary illustration of food processing equipment in accordance with an embodiment of the present invention;

FIG. 3 is a perspective view of a material employed in accordance with and aspect of the present invention;

FIGS. 4-6 are detailed illustrations depicting the application of the present invention to a water absorbing embodiment;

FIGS. 7 and 8 are alternative embodiments of a material used in accordance with the present invention;

FIG. 9 is an illustration of a pair of brushes employed in an aspect of the present invention; and

FIG. 10 is an illustrative example of yet another aspect of the present invention.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by the appended claims.

### DESCRIPTION OF THE PREFERRED EMBODIMENT

For a general understanding of the present invention, reference is made to the drawings. In the drawings, like reference numerals have been used throughout to designate identical elements. In the following description, the term “anti-microbial” has been employed to generally represent a substance or treatment that inhibits the growth of microorganisms, wherein various agents or additives may be employed to produce such characteristics. Anti-microbial includes those agents, additives or treatments that are characterized as antibacterial and antifungal. “Antibacterial” refers to an agent or treatment that prevents the growth of bacteria, and can be bactericidal (kills) or bacteriostatic (inhibits growth). “Antifungal” refers to an agent or treatment that prevents the growth of fungi and may be fungicidal (kills) or fungistatic (inhibits growth).

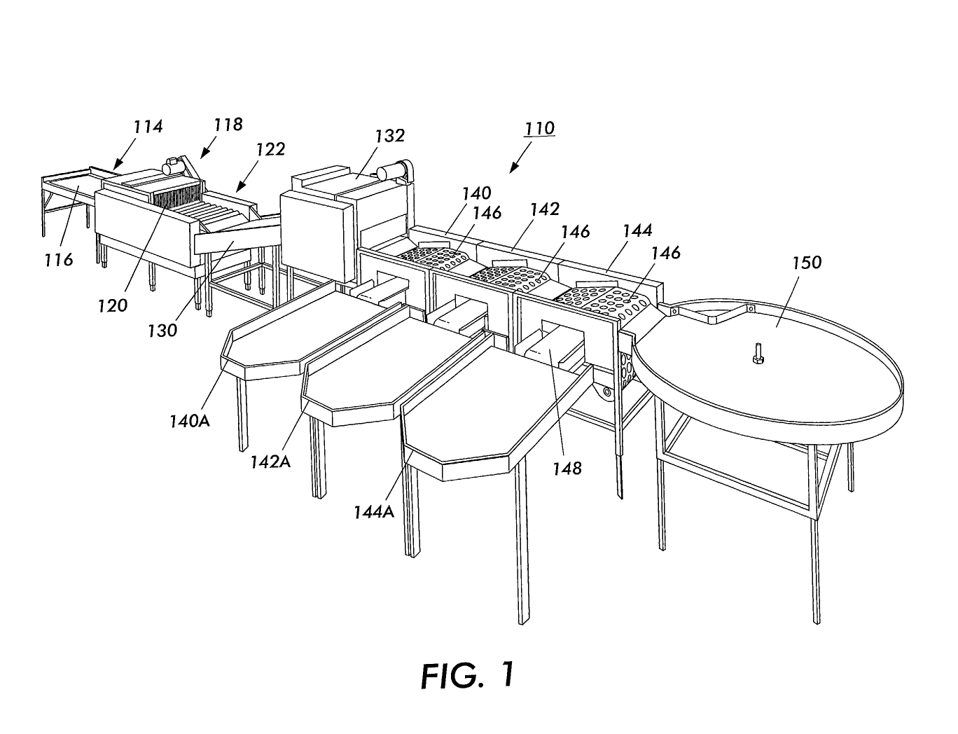

Referring first to FIG. 1, there is depicted a produce handling system, such as a “Tomato Packing Line (Model ST) as sold by Tew Manufacturing Corp. of Penfield, N.Y. The system 110, comprises a produce receiver 114 in the form of a receiver belt conveyor, wherein the conveyor provides a safe means of loading produce into the system. The receiver is preferably adjustable in height and equipped with a smooth belt 116 to advance the produce deposited thereon. As depicted, the receiver belt is a generally horizontal receiving surface and is surrounded by at least two opposing sides adjacent thereto to retain produce on the receiving surface or belt 116.

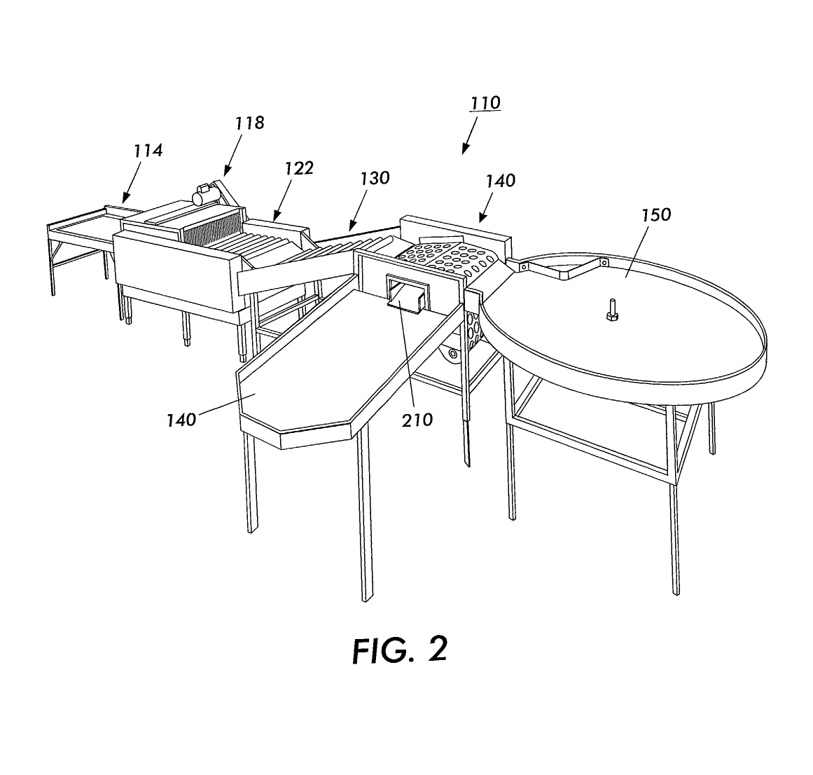

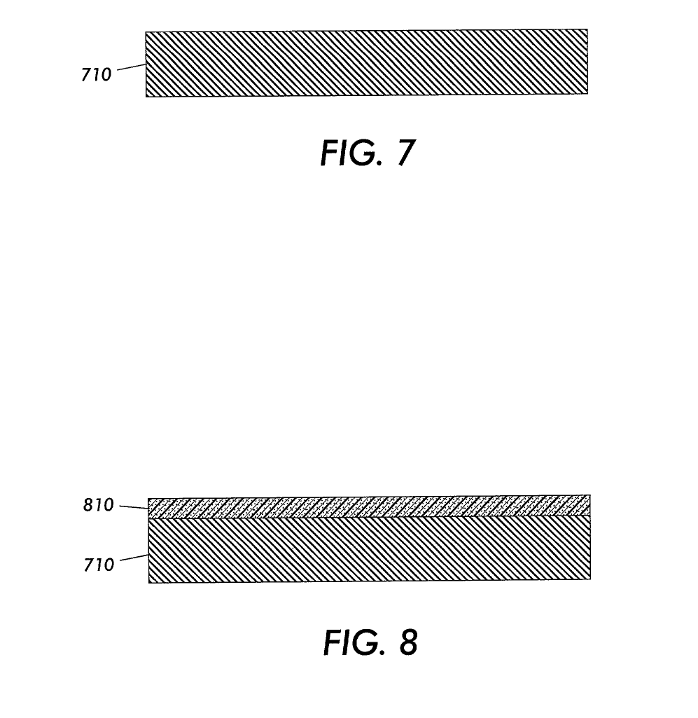

Adjacent the produce receiver is a produce washer or washing station 118. Although dirt may be removed from produce (e.g., potatoes) using a dry brushing method, the present invention contemplates a wet washer 118, wherein the washer includes a plurality of 3.5 inch brushes (see FIG. 9), and spray nozzles for spraying water at 1-5 gallons-per-minute for washing the produce as it is transported therethrough. Washer 118 preferably includes a drape 120 on at least one end thereof, wherein the drape prevents the spray from exiting the washer on the outbound end. Drape 120, as will be described in further detail below may be made of a vinyl material, wherein the vinyl is formed using an antimicrobial agent during the manufacture process. Accordingly the drape will be resistant to the growth or formation of microbes thereon. Washer 118 may also employ a scrubber rubber material 310 therein, as depicted for example in FIG. 3, which is suitable for use in dislodging larger dirt clumps or other residue from the produce or food product being processed.

Referring briefly to FIG. 9, a pair of brushes 908 is depicted, where the brushes used in the washer include a core or central cylindrical element 910 from which a plurality of bristle clusters 914 extend radially therefrom. The bristles in the clusters are each preferably formed from materials such as DURASTRAN, NYLON or PROLENE, and their equivalents, wherein an antimicrobial agent has been added at the time of manufacture or by a post-manufacture treatment. Such bristle fibers are available, for example, from Dupont under the name TYNEX® Antibacterial filaments where they are noted for use with toothbrushes. It will also be appreciated that alternatives shapes and configurations of brushes may be employed in the washer.

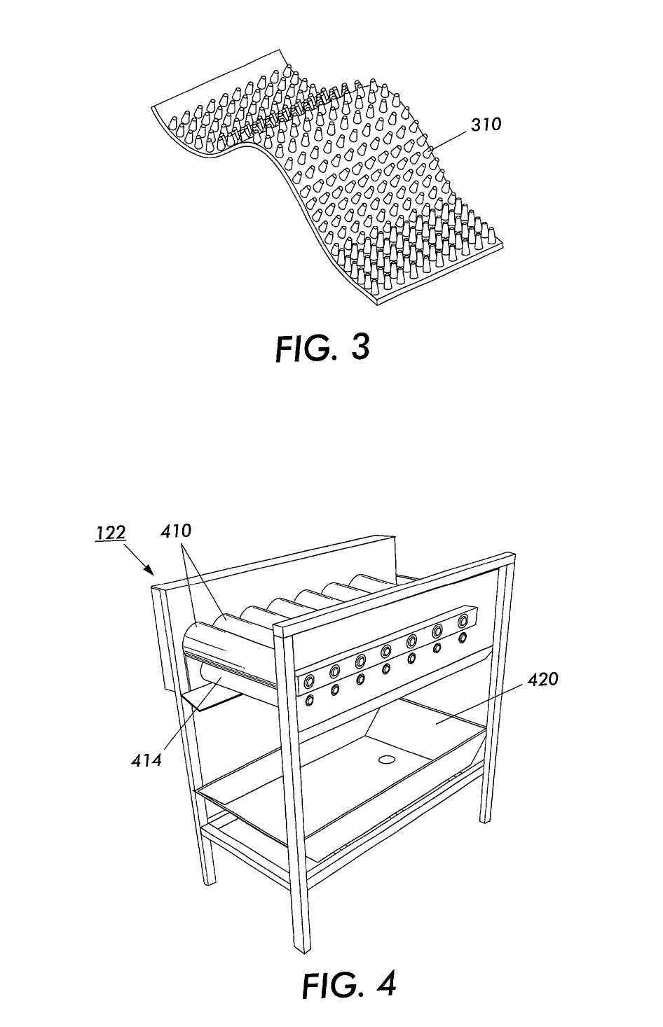

At the output of the washer 118, the produce is preferably supported upon a series of water-absorbent rollers at water absorber 122. Absorber 122 is intended to support the produce while removing excess water as it leaves the washer. Further details of the construction and operation of absorber 122 will be provided in the description of FIGS. 4-6.

The next station in the processing line is a roller inspection conveyor 130 that moves produce to the entrance of a waxer 132 that may be employed to apply hot wax to some produce (e.g., tomatoes, cucumbers, peppers). The waxer preferably includes a plurality of bed brushes and an overhead applicator. Subsequent to the waxer are a series of three sizing stations 140, 142 and 144,; and associated packing tables 140A, 142A and 144A. At the end of the system is a rotary packing table 150, suitable for receiving produce that has not been previously sorted, based upon size, by the series of sizing units. It will be appreciated that various configurations and embodiments of the stations described herein may be employed, depending upon the type of food or produce being processed.

Continuing with FIG. 1, it will be appreciated that at various points of the processing system, produce is likely to contact or touch a surface of the equipment. For example, in sizing units 140-144, the produce may fall through a hole in sizing belt 146 where it might strike an angled chute before it comes to rest on conveyor belt 148. Similarly, the table surface of packing tables 142A-144A and on rotary table 150 are locations where the produce may be bumped or dropped onto a hard surface. In accordance with an aspect of the present invention the various contact surfaces of the equipment are preferably covered or protected from the produce by a foam padding. In other words, a foam padding covers at least one produce-contacting surface of the machine. The foam padding is intended to reduce bruising of the produce. Moreover, in accordance with the present invention, the padding is formed with an anti-microbial agent to retard the growth of microbes on and within the padding.

Referring briefly to FIG. 2, there is depicted an alternative arrangement of system or machine 110, suitable for use with produce such as potatoes. In this embodiment, the waxer has been removed, and the sizer is connected to the packing table by a padded chute 210 rather than by a conveyor as previously described. Here again, the chute would preferably include a padding material that includes an antimicrobial agent therein to retard or prevent the growth of bacteria and fungus in or on a surface of the padding.

Turning next to FIGS. 4-6, the various aspects of the water absorber station 122 will be described in more detail. Referring to FIG. 4, station 122 includes a plurality of water absorbing rolls 410 that are each operatively in contact with wringer/drive rolls 414. The donut-style rolls 410 support the produce exiting from the washer as previously described. Moreover, the rolls are preferably manufactured from an open-cell foam that has a anti-microbial agent included therein. In one embodiment, the anti-microbial properties are achieved by adding an anti-microbial agent during the manufacture of the open-cell foam. The foam may be a latex foam such as that distributed by Ludlow Composites Corp. of Fremont, Ohio and described as “Latex Foam with Bactericide.” Alternatively, the foam may be a polyurethane-based foam, again incorporating an antimicrobial agent such as Ultrafresh or similar additive.

It will be appreciated that various additives or agents may be employed, depending upon the foam application, for use in accordance with the present invention. For example, the additive Ultrafresh™ produced by Thompson Research Associates of Canada, and registered for use with the U.S. Environmental Protection Agency in 1981 (Tributyltin Maleate [083118]) is an antimicrobial agent. Another example is the AgION™ antimicrobial compound, with an active ingredient of silver, and a naturally occurring inorganic ceramic that permits a continuous, controlled release of ionic silver over an extended time period. The AgION™ antimicrobial compound has been successfully and cost effectively incorporated into fibers and fabrics, molded plastics, plastic films and coatings for metals, with proven effectiveness and safety. Lastly, various anti-microbial agents are disclosed in the patents and other publications previously incorporated by reference above. The present invention is not intended to be limited to the type of antimicrobial additive employed to achieve the desired characteristics.

Returning to the water absorber, it will be appreciated that the materials of rollers 410 are preferably open-celled foams so as to increase the wicking (capillary action) of the foam and to produce a drier produce item than would be possible with a closed-cell foam. However, open-celled foams will inherently collect any microbes that are present on the produce that they are drying. Although wringer/drive rollers 414 are operated to wring the water from the donut-style rolls 410, which is collected in drain pan 420, they are unable to wring all the water or liquid therefrom. The plurality of wringer rolls 414 is, therefore, located in contact with the donut-style rolls, as depicted in FIG. 5, to compress the foam and thereby eliminate water attracted to surfaces within the open-cell foam.

The present invention contemplates the wear of the donut-style rollers, and therefore provides replacement donuts, referred to as “sponge rubber donuts” that may be slipped over a roller shaft or core. Such replacement donuts 430, as depicted in FIG. 6, are used to build up a roller 410 by sliding the required number of donuts over the core 432. The dimensions of the donuts are dependent upon the equipment and use, but generally range from 4 inches to 7 inches in outside diameter, and with an inside diameter of 0.75 inches to 3.0 inches. The donuts are often approximately 1.5 inches in thickness, however it will be appreciated that various thicknesses or alternative dimensions may be employed in accordance with the present invention. In a preferred embodiment, however, the donuts 430 are preferably punched or cut from a sheet of padding material that includes an antimicrobial agent therein so as to retard or prevent the growth of microbes in or on the donuts.

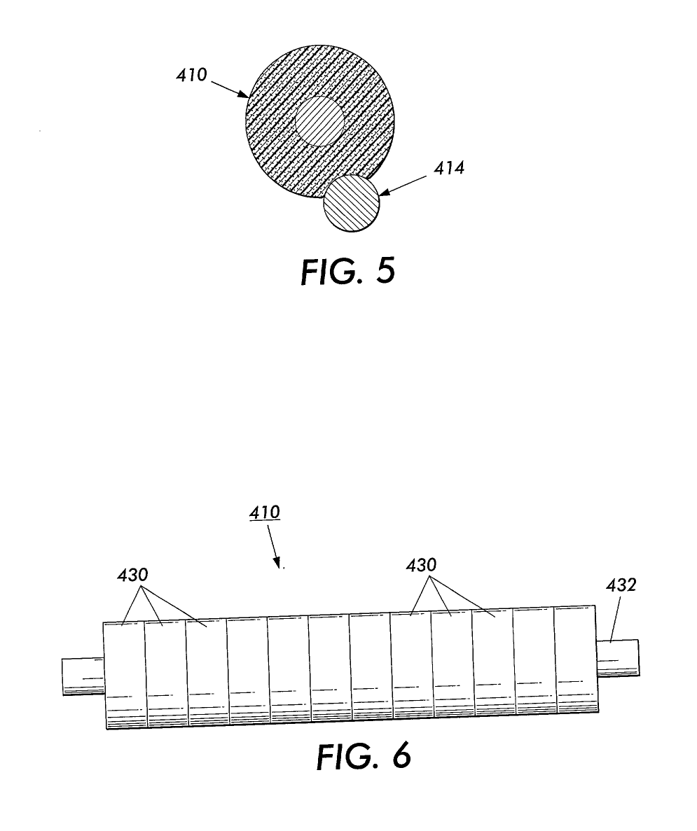

Having described a particular application for the use of closed-cell foam, attention is now turned to FIGS. 7-8, where embodiments of closed-cell foams are described, and in particular applications for the use of closed-cell foams in padding materials used in the handling, processing and packing of foodstuffs as described herein. Referring to FIG. 7, there is depicted a closed-cell foal layer, having a thickness from about 0.125 inches to 1.5 inches and thicker, where the foam may be applied to a surface of the food processing equipment to prevent bruising or breaking of the food item (e.g., produce, eggs, etc.). Such a foam may be made from polyvinyl chloride (PVC), neoprene, latex, latex composites, urethanes, polyesters, polyethylene and other suitable materials.

The padding material of FIG. 7 includes a layer of closed-cell foam 710. The layer may be affixed to surface of the processing system (e.g., FIGS. 1 and 2) using conventional adhesives such as “rubber cement” or double-sided tapes. Applying the padding to drop points, conveyor and table sides and other contact locations will reduce the damage to the food or produce. Similarly, the use of the previously described additives (e.g., Ultrafresh™) in the manufacture of the foam will reduce the likelihood that such foams will allow the propagation of microbes on the other surface or in cuts or abrasions to the foam.

As a further improvement, designed for portions of the process known to result in high levels of abrasion or damage to the foam surface due to produce contact, the present invention contemplates the use of a material such as that depicted in FIG. 8, wherein the foam padding layer 710 further includes a flexible outer layer 810 that will withstand greater amounts of abrasion than the foam layer. In particular, it is contemplated that layer 810 be made of vinyl or a similar material that will provide abrasion resistance yet will not be so stiff as to diminish the shock-absorbing capacity of the underlying foam layer 710. Such a material is sold by Ludlow Composites as “Vinyl Foam with Printable Skin.” Here again, the flexible outer layer 810 may be formed with an anti-microbial agent to retard the growth of microbes on exposed surfaces thereof.

In addition to the particular applications described in detail above, the use of an antimicrobial foam layer (with or without an outer layer) may find additional application in the produce picking and processing industry. One such example is in the machine of FIGS. 1 and 2, wherein the roller inspection conveyor 130 includes a plurality of parallel conveyor rolls including at least an outer layer of foam having anti-microbial properties. Another embodiment may be on picking equipment (e.g., fruit tree shakers) where produce is dropped from significant heights onto angled surfaces. In such embodiments the closed-cell foam is believed preferable and it is also believed that a flexible layer covering the foam, as depicted in FIG. 8, may further improve resistance to abrasion of the foam surface. Accordingly, the present invention is contemplated to include a produce handling machine having a foam padding covering at least a portion of a produce-contacting surface of the machine. Moreover, the foam padding is intended to reduce bruising of the produce contacting the surface and where the foam padding is formed with an anti-microbial agent to retard the growth of microbes on the padding. It will be appreciated that such applications may require the forming or molding, to shape, of the foams and that such processing is within the nature of well-known techniques for the formation of such foams.

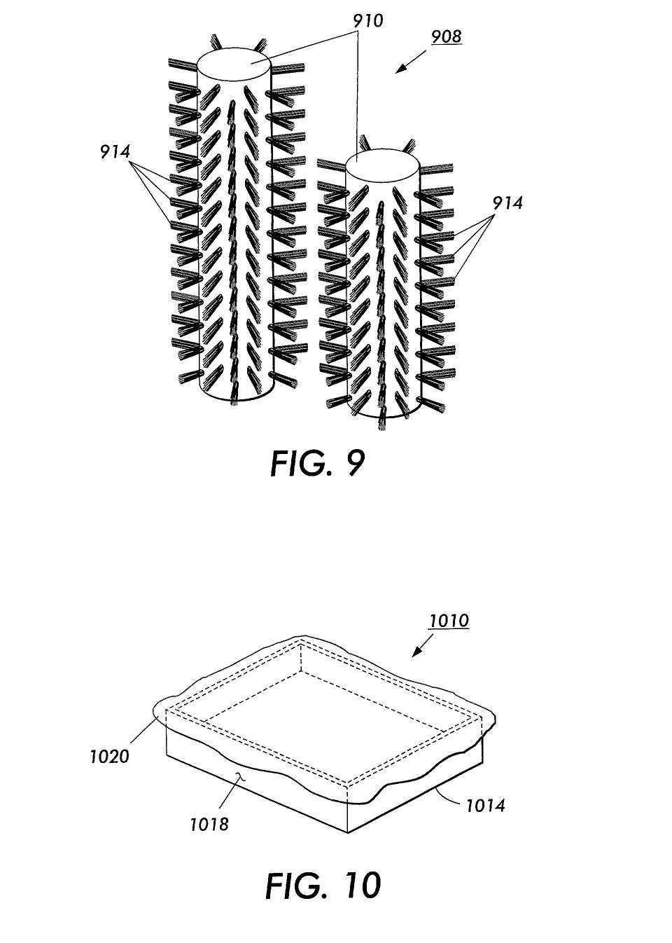

It will also be appreciated that aspects of the present invention may be employed the packing, transportation and display of produce or other foodstuffs. For example, such foams and antimicrobial agents may be used in the formation of packaging and display surfaces (e.g., store shelves). An example of such an application is the food storage and/or display container of FIG. 10. In particular, it is contemplated that container or shelf unit 1010 may be loaded with fruit or produce for shipping, display and/or storage. Unit 1010 consists of a rigid, semi-rigid or collapsible container or shelf 1014 that may have raised sides 1018 within which the produce is retained. It will be appreciated that the dimensions and arrangements of sides 1018 may be such that allow the units to be stacked and palletized for easy display and/or storage of the produce. In accordance with the present invention, the container may include a padding sheet 1020 to line the bottom and/or sides of the unit.

Furthermore, the padding material is preferably made from a shock-absorbing foam or similar material that has anti-microbial characteristics. Examples of such materials include those described previously, including both open and closed-cell foams and foams having outer skins or layers such as depicted and previously described with respect to FIG. 8. It is further contemplated that the upper layer of such a sheet may also consist of vinyl or a perforated cloth or similar material that will improve the aesthetic appearance of the underlying foam sheet 1020. The use of an anti-microbial padding material, particularly one having an open-cell foam may aid in the control and absorbtion of water from misters commonly found at produce areas in grocery stores. It is further contemplated that the foam display or packing liners may be either disposable or re-usable liners.

It will, as noted previously, be apparent to those skilled in the art of antimicrobial agents that equivalents and alternatives to the Ultrafresh™ antimicrobial agent may be employed. Accordingly, the present invention is intended to include all such alternatives, particularly including those disclosed in the patents and other publications incorporated herein by reference.

In recapitulation, the present invention is an improved produce handling material, and more particularly to the use of anti-microbial additives in the production of padding and other materials for produce handling equipment.

It is, therefore, apparent that there has been provided, in accordance with the present invention, a method and apparatus for reducing the likelihood of growth of microbes in produce and food-handling equipment. While this invention has been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

1. A produce handling machine, comprising:
a produce receiver having a generally horizontal receiving surface and at least two opposing sides adjacent thereto to retain produce on the receiving surface;
a produce washer, adjacent the produce receiver, for washing the produce as it is transported therethrough;
a water absorber, adjacent said produce washer, for movably supporting the produce and to remove excess water from the produce as it exits the washer; and
a foam padding covering at least one produce-contacting surface of the machine, wherein said foam padding is intended to reduce bruising of the produce and where said foam padding is formed with an anti-microbial agent to retard the growth of microbes within the padding.

2. The machine of claim 1, wherein said water absorber includes a plurality of donut-style rolls for supporting the produce, and where said rolls are manufactured from an open-cell foam that has anti-microbial properties.

3. The machine of claim 2, wherein the anti-microbial properties are achieved by adding an anti-microbial agent during the manufacture of the foam.

4. The machine of claim 3, wherein the foam is a latex foam.

5. The machine of claim 2, further comprising a plurality of wringer rolls, located in contact with the donut-style rolls, to compress the foam and thereby eliminate water attracted to surfaces within the open-cell foam.

6. The machine of claim 1, wherein the foam padding covering at least one produce-contacting surface of the machine, is a closed-cell foam.

7. The machine of claim 1, wherein the foam padding covering at least one produce-contacting surface of the machine further includes a flexible outer layer of vinyl.

8. The machine of claim 7, wherein the flexible outer layer of vinyl is formed with an anti-microbial agent to retard the growth of microbes on exposed surfaces thereof.

9. The machine of claim 1, further comprising a roller inspection conveyor for transporting the produce while turning it for inspection, wherein the inspection conveyor includes a plurality of parallel conveyor rolls and where said conveyor rolls include at least an outer layer of foam having anti-microbial properties.

10. The machine of claim 1, further comprising a sizer, wherein the sizer has at least one drop surface that is covered with padding and where the padding is produced with an anti-microbial agent to provide resistance to the growth of microbes thereon.

11. The machine of claim 1, further comprising packing table wherein the packing table has at least one surface that is covered with padding and where the padding is produced with an anti-microbial agent to provide resistance to the growth of microbes thereon.

12. The machine of claim 1, further comprising a drape produced with an anti-microbial agent to provide resistance to the growth of microbes thereon.

13. The machine of claim 1, wherein said produce washer further comprises scrubber rubber produced with an anti-microbial agent to provide resistance to the growth of microbes thereon.

14. The machine of claim 1, further comprising a brush within the produce washer, wherein the brush has bristles produced with an anti-microbial agent to provide resistance to the growth of microbes thereon.

15. A produce handling machine, comprising:
at least one produce-contacting surface; and
a foam padding covering at least a portion of said produce-contacting surface of the machine, wherein said foam padding is intended to reduce bruising of the produce contacting the surface and where said foam padding is formed with an anti-microbial agent to retard the growth of microbes on the padding.

16. The produce handling machine of claim 15, wherein the foam padding is a closed-cell foam.

17. The machine of claim 15, wherein the foam padding further includes a continuous yet flexible outer layer.

18. The machine of claim 17, wherein the flexible outer layer comprises a vinyl compound formed with an anti-microbial agent to retard the growth of microbes on surfaces coming in contact with the produce.

19. The machine of claim 15, wherein said foam padding is molded to shape.

20. A food handling apparatus, comprising:
a stationary member for the support of a food item; and
a covering for at least one food-contacting surface of the member, wherein said covering is formed with an anti-microbial agent to retard the growth of microbes.

21. The food handling apparatus of claim 20, wherein said covering comprises a foam padding.
